(19) United States
(12) Patent Application Publication
(10) Pub. No.: US 2008/0192729 A1
(43) Pub. Date: Aug. 14, 2008

(54) Multimedia Gateway

(76) Inventors: Patrick Kleiner, Munchen (DE); Mohammad Vizaei, Wien (AT); Walter Zinkl, Wien (AT)

Correspondence Address: BELL, BOYD & LLOYD, LLP, P.O. BOX 1135, CHICAGO, IL, 60690, US

(21) Appl. No.: 10/592,307

(22) PCT Filed: Mar. 11, 2005
(86) PCT No.: PCT/EP2005/005118

§ 371 Date: Jul. 12, 2007

(30) Foreign Application Priority Data
May 19, 2004 (IT) RE2004A000057

(51) Int. Cl. H04L 29/06; H04L 12/66; H04L 29/08

(52) U.S. Cl. 370/352; 370/466; 370/467

(57) ABSTRACT

In one aspect, a multimedia gateway for connecting a first computer network to a non-compatible second computer network is provided. The gateway having a first function block, a second function block and a third function block. The first function block establishes a multimedia data transmission with subscribers of the first computer network according to the specific protocols of the first network, the useful data, signaling data, and performance characteristics being buffered separately in respectively associated first signaling-specific, state-sensitive stacks. The second function block establishes a multimedia data transmission with subscribers of the second computer network according to the specific protocols of the second network, the useful data, signaling data, and performance characteristics being buffered separately in respectively associated second signaling-specific, state-sensitive stacks. The third function block converts the signaling data, performance characteristics and useful data between the first function block and the second function block.

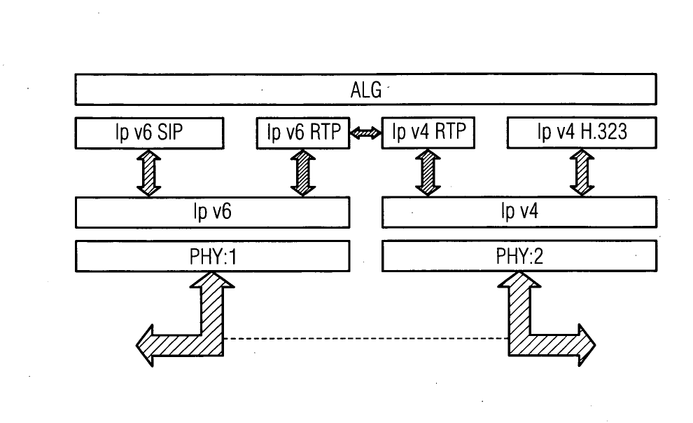

### CROSS REFERENCE TO RELATED APPLICATIONS

This application is the US National Stage of International Application No. PCT/EP2005/051118, filed Mar. 11, 2005 and claims the benefit thereof. The International Application claims the benefits of European application No. 04005762.2 filed Mar. 11, 2004, both of the applications are incorporated by reference herein in their entirety.

### FIELD OF INVENTION

The invention relates to a multimedia gateway for connecting non-compatible computer networks.

### BACKGROUND OF INVENTION

Over the last several years computer networks have evolved into an important communication medium via which a plurality of services are provided. The best-known computer network worldwide is the internet, which is the term used to refer to the totality of all interconnected networks that use the Internet Protocol IP as the transport protocol.

The Internet Protocol IP is responsible on layer 3 of the OSI layer model for the connectionless transport of data from a transmitter—possibly over a plurality of networks—to the receiver, with neither error detection nor error correction being performed.

The Internet Protocol serves as a basis on top of which transport run protocols such as the Transmission Control Protocol TCP or User Datagram Protocol UDP, and on these in turn run a virtually unlimited diversity of different, sometimes competing, application protocols such as, for example, http, FTP or, for the management of multimedia connections, what is referred to as the SIP protocol.

For this reason great importance is attached to the gateways which translate the protocol data units at the interfaces between the individual non-compatible networks.

### SUMMARY OF INVENTION

An object underlying the invention is to specify a gateway for multimedia communication.

This object is achieved according to the invention by means of a multimedia gateway for connecting a first computer network to a non-compatible second computer network having the following components:
a first function block for setting up a multimedia data transfer with subscribers of the first computer network according to the specific protocols of said network, with payload data and signaling data together with service features being buffered separately in assigned first signaling-specific, state-sensitive first-in/first-out stores in each case,
a second function block for setting up a multimedia data transfer with subscribers of the second computer network according to the specific protocols of said network, with payload data and signaling data together with service features being buffered separately in assigned second signaling-specific, state-sensitive first-in/first-out stores in each case, and
a third function block for converting the signaling data together with service features and the payload data between first function block and second function block.

The gateway is characterized by a particularly high degree of flexibility and versatile application possibilities.

It is advantageous if the first computer network is based on the Internet Protocol Version 6 and the first function block supports said protocol, and if the second computer network is based on the Internet Protocol Version 4 and the second function block uses said protocol and that the third function block performs the conversion of the protocol data.

In this way the multimedia gateway according to the invention can be used to implement the interworking functionality between Version 4 IP networks and Version 6 IP networks while retaining the service features.

A particularly advantageous application scenario is given if the multimedia data transfer in the first computer network is performed in accordance with the Session Initiation Protocol SIP and the first function block supports said protocol as the SIP proxy and the second function block in the second computer network is set up as a subscriber participating in a multimedia data transmission conforming to the H.323 standard and that the third function block converts the signaling data according to the Session Initiation Protocol SIP and the service features contained therein into signaling data according to the H.323 standard, the service features being converted in accordance with the H.323 standard and H.450 protocol.

For multimedia connections over the internet there currently exist two competing standards for the signaling: H.323 and SIP. The ITU standard H.323 (ITU: International Telecommunication Union) was developed for the real-time transmission of multimedia applications such as voice and video communication in packet-oriented networks. As what is referred to as an “umbrella standard”, it accommodates a series of protocols, e.g. for signaling, exchanging terminal device functionalities and status information, as well as for link and data flow control. The most important protocols of the H.323 standard include H.225, H.245 and H.450.x. H.225 describes signaling protocols such as RAS (Registration, Admission, Status) and Call Signaling. H.245 acts as a control protocol for multimedia communication. The H.450 standard defines additional telephony functions in order, for example, to map the service features of ISDN to IP.

The Session Initiation Protocol SIP was developed by the IETF (Internet Engineering Task Force). The standard defines a signaling protocol for setting up, modifying and terminating sessions with two or more subscribers. The Session Initiation Protocol SIP likewise serves for the transmission of real-time data over packet-based networks and is functionally comparable with the protocols conforming to ITU standard H.323: The Session Initiation Protocol SIP can switch interactive communication services including voice over IP networks, the transport operating via TCP (Transmission Control Protocol) or UDP (User Datagram Protocol). At the same time the Session Initiation Protocol SIP is responsible for call signaling as well as the localization and registration of users. More particularly, however, it also enables the transmission of the identity of the caller as well as call forwarding in IP networks. The Session Initiation Protocol SIP is text-oriented, based on HTTP (Hypertext Transfer Protocol) and consequently offers an open, internet-based structure. For this reason new service features can be implemented relatively easily and quickly.

A further important standard for multimedia connections is the Media Gateway Controller Protocol MGCP, which supports telephony between the internet and the traditional telephone network and for this purpose provides a connection control protocol (no signaling protocol). Both the H.323 standard and the Session Initiation Protocol SIP can be used as the protocol for transmitting MGCP control commands.

At the same time the invention is also advantageously applicable for converting protocol data according to the H.323 standard and also according to the Session Initiation Protocol SIP into MGCP control commands.

It is therefore particularly favorable to use a multimedia gateway according to the invention wherein the multimedia data transmission in the first computer network is performed according to the H.323 standard and the first function block supports this protocol as an H.323 gatekeeper and the second function block in the second computer network is set up as a subscriber participating in a multimedia data transmission according to the Media Gateway Controller Protocol MGCP standard and wherein the third function block converts the signaling data according to the H.323/H.450 protocols and the service features contained therein into connection control data according to the MGCP standard.

Also favorable is the use of a multimedia gateway according to the invention wherein the multimedia data transmission in the first computer network is performed according to the Session Initiation Protocol SIP and the first function block supports said protocol as an SIP proxy and the second function block in the second computer network is set up as a subscriber participating in a multimedia data transmission according to the Media Gateway Controller Protocol MGCP standard and wherein the third function block converts the signaling data according to the Session Initiation Protocol SIP and the service features contained therein into connection control data according to the MGCP standard.

### BRIEF DESCRIPTION OF THE DRAWING

The invention is explained in more detail with reference to an exemplary embodiment depicted schematically in the sole FIGURE.

The example illustrates the use of a gateway according to the invention at a crossover from a first internet domain which uses Internet Protocol Version 6 IPv6 as well as, inter alia, the Session Initiation Protocol SIP to a second internet domain which is based on Internet Protocol Version 4 Ipv4 and ITU standard H.323.

### DETAILED DESCRIPTION OF INVENTION

The FIGURE shows a call setup between a subscriber of the first domain and a subscriber of the second domain. The term “domain”, in this context, designates a strictly delimited addressable area of a computer network which may be, for example, what is referred to as an intranet or even the entire network of an operator.

According to the invention the call is now converted by the multimedia gateway in spite of the different conditions in the two incompatible domains in such a way that the two subscribers are able to access the full scope of services provided in both networks, even across the network boundaries.

The associated sequence is as follows:

A call is initiated according to the Session Initiation Protocol SIP by means of the request INVITE which, in the case of a destination address in the second domain, is routed to the gateway. The routing operation is performed in accordance with the Internet Protocol IP and the transport protocols Transmission Control Protocol TCP or User Datagram Protocol UDP.

In the concrete example the two domains run different versions of the Internet Protocol—Internet Protocol Version 6 IPv6 and Internet Protocol Version 6 Ipv4 respectively—with different addressing, with the result that an address transfer has to take place in the gateway according to the invention.

According to the invention the data for the Session Initiation Protocol SIP is separated from the data according to the Real Time Protocol RTP in the first function block PHY:1; IPv6; Ipv6 SIP; IPv6.RTP. The RTP data stream is buffered in the first function block and the Internet Protocol data is converted from Version 6 to Version 4, in particular the crucial difference of the addressing being resolved by Network Address Translation.

With regard to the signaling data according to the SIP protocol, the first function block PHY:1; IPv6; Ipv6 SIP; IPv6.RTP behaves in the manner of a USER AGENT SERVER which terminates the incoming call correctly in accordance with the protocol, i.e. performs the signaling handshake and handles payload data (voice, video, multimedia content). The information necessary for this is buffered in a signaling-specific, state-sensitive signaling first-in/first-out store.

Said information serves on the one hand to ensure the correctly conducted dialog with the calling subscriber from the first domain, and on the other hand the data is used to translate the signaling into the H.323 protocol by means of the third function block.

The H.323 protocol data obtained in this way is passed to the second signaling-specific, state sensitive signaling first-in/first-out store Ipv4 H.323 of the second function block PHY:2; IPv4; IPv4 H.323; IPv4.RTP and serves as a basis for communication between the second function block and the called subscriber of the second network.

The inventive transformation of the signaling is also used to translate service features.

The term “service features” serves to designate functionalities of a terminal device which are intended, for example, to facilitate and simplify the operation of said terminal device or else to extend the communication options.

Examples of said service features are
Call transfer
Call waiting
Three-party call
Call number display (CLIP)
Automatic callback

According to the invention service features of this type are also translated from the Session Initiation Protocol SIP, for example, into the H.450 protocol provided for this purpose in the H.323 standard. Said translation is performed “intelligently”, i.e. it is provided that individual items of information which the sending standard does not supply in full are completed automatically in the third function block ALG. According to the invention, said service features are terminated on one ‘gateway half’ and converted to the other ‘gateway half’, i.e. the signaling traffic with the first subscriber according to the Session Initiation Protocol SIP is terminated in the proper way in the manner of a SIP subscriber and a call conforming to the H.323 standard or H.450 protocol is set up on the output side in the second domain.

The exemplary embodiment simply describes a call from the first domain to the second domain. However, calls in the other direction, i.e. from a network operating with Internet Protocol Version 4 and the H.323 standard to a network operating with Internet Protocol Version 6 and the Session Initiation Protocol SIP, are also converted in an analogous manner.

Although the invention can advantageously be used with the previously cited protocols IPv4, Ipv6, SIP, H.323 MGCP, MEGACO (H.248), it is not restricted thereto, and the multimedia gateway according to the invention is suitable in principle as an interface for establishing interoperability for non-compatible computer networks.

1.-5. (canceled)

6. A multimedia gateway for connecting a first computer network to a non-compatible second computer network, the gateway comprising:
a first function block that sets up a multimedia data transmission with a subscriber of the first network according to protocols of the first network, wherein:
the transmission having a payload data and a signaling data,
the signaling data having a service feature,
the payload data and signaling data separated,
the separated payload data stored in a first buffer and the separated signaling stored in a first signaling-specific, state-sensitive first-in/first-out store;
a second function block that sets up a multimedia data transmission with a subscriber of the second network according to protocols of the second network, wherein:
the transmission having a payload data and a signaling data,
the signaling data having a service feature,
the payload data and signaling data separated,
the separated payload data stored in a second buffer and the separated signaling stored in a second signaling-specific, state-sensitive first-in/first-out store; and
a third function block that converts the signaling data with the service feature in the first store to the second store.

7. The multimedia gateway as claimed in claim 6,
wherein the first network is based on an Internet Protocol Version 6 that is supported by the first function block,
wherein the second network is based on Internet Protocol Version 4 that is supported by the second function block, and
wherein the third function converts between the protocols.

8. The multimedia gateway as claimed in claim 7,
wherein the multimedia data transmission in the first network is performed in accordance with a Session Initiation Protocol,
wherein the first function block supports the Session Initiation Protocol as a SIP proxy,
wherein the second function block supports a H.323 protocol, and
wherein the third function block converts the signaling data and the service feature in the data transmission between the Session Initiation Protocol in the first function block and the H.323 protocol and a H.450 protocol in the second block.

9. The multimedia gateway as claimed in claim 7,
wherein the transmission in the first computer network is performed in accordance with an H.323 protocol,
wherein the first function block supports the H.323 protocol as an H.323 gatekeeper,
wherein the second function block supports a Media Gateway Controller Protocol, and
wherein the third function block converts the signaling data and the service feature in the data transmission between the H.323 protocol and a H.450 protocol in the first function block and the Media Gateway Controller Protocol in the second function block.

10. The multimedia gateway as claimed in claim 7,
wherein the multimedia data transmission in the first computer network is performed in accordance with the Session Initiation Protocol,
wherein the first function block supports the Session Initiation Protocol as a SIP proxy,
wherein the second function block supports a Media Gateway Controller Protocol, and
wherein the third function block converts the signaling data and the service feature in the data transmission between the Session Initiation Protocol in the first function block and the Media Gateway Controller Protocol in the second function block

11. The multimedia gateway as claimed in claim 6,
wherein the multimedia data transmission in the first network is performed in accordance with a Session Initiation Protocol,
wherein the first function block supports the Session Initiation Protocol as a SIP proxy,
wherein the second function block supports a H.323 protocol, and
wherein the third function block converts the signaling data and the service feature in the data transmission between the Session Initiation Protocol in the first function block and the H.323 protocol and a H.450 protocol in the second block.

12. The multimedia gateway as claimed in claim 6,
wherein the transmission in the first computer network is performed in accordance with an H.323 protocol,
wherein the first function block supports the H.323 protocol as an H.323 gatekeeper,
wherein the second function block supports a Media Gateway Controller Protocol, and
wherein the third function block converts the signaling data and the service feature in the data transmission between the H.323 protocol and a H.450 protocol in the first function block and the Media Gateway Controller Protocol in the second function block.

13. The multimedia gateway as claimed in claim 6,
wherein the multimedia data transmission in the first computer network is performed in accordance with the Session Initiation Protocol,
wherein the first function block supports the Session Initiation Protocol as a SIP proxy,
wherein the second function block supports a Media Gateway Controller Protocol, and
wherein the third function block converts the signaling data and the service feature in the data transmission between the Session Initiation Protocol in the first function block and the Media Gateway Controller Protocol in the second function block

14. A method for connecting a first network having a first subscriber to a non-compatible second network having a second subscriber via a multimedia gateway, comprising:
supporting a first set of protocols used by the first network, the first set of protocols including a first network layer protocol and a first signaling protocol;
supporting a second set of protocols used by the second network, the second set of protocols including a second network layer protocol and a second signaling protocol;
providing a first data transmission from the first network, the data transmission including a signaling portion in accordance to the first signaling protocol and a payload portion in accordance to the first network layer protocol;
converting the payload portion from a first network layer protocol to a second network layer protocol;
storing the signaling portion in a first signaling-specific, state-sensitive signaling first-in/first-out store;
performing a signaling handshake in response to the first data transmission;
converting the signaling portion from a first signaling protocol to a second signaling protocol;
storing the converted signaling portion in a second signaling-specific, state-sensitive signaling first-in/first-out store; and
communicating a second data transmission based on the second store and the second network layer protocol.

15. The method as claimed in claim 14,
wherein the first network layer protocol is in accordance with an Internet Protocol Version 6, and
wherein the second network layer protocol is in accordance with an Internet Protocol Version 4.

16. The method as claimed in claim 15,
wherein the first signaling protocol includes a Session Initiation Protocol, and
wherein the second signaling protocol includes a H.323 protocol,

17. The method as claimed in claim 16,
wherein the second signaling protocol further includes a H.450 protocol.

18. The method as claimed in claim 15,
wherein the first signaling protocol includes a H.323, and
wherein the second signaling protocol includes a Media Gateway Controller Protocol.

19. The method as claimed in claim 18,
wherein the first signaling protocol further includes a H.450 protocol.

20. The method as claimed in claim 15,
wherein the first signaling protocol includes a Session Initiation Protocol, and
wherein the second signaling protocol includes a Media Gateway Controller Protocol.
